(19) United States
(12) Patent Application Publication
(10) Pub. No.: US 2018/0124911 A1
(43) Pub. Date: May 3, 2018

(54) INSERTION DEVICE

(71) Applicant: Hitachi Metals, Ltd., Tokyo (JP)

(72) Inventors: Hideo KITAMURA, Kobe-shi (JP); Masami ARAKAWA, Takasaki-shi (JP)

(73) Assignee: Hitachi Metals, Ltd., Tokyo (JP)

(21) Appl. No.: 15/572,261

(22) PCT Filed: Jul. 29, 2016
(86) PCT No.: PCT/JP2016/072352

§ 371 Date: Nov. 7, 2017

(30) Foreign Application Priority Data
Jul. 31, 2015 (JP) 2015-152529
May 12, 2016 (JP) 2016-096468

(51) Int. Cl. H05H 7/04

(52) U.S. Cl. CPC H05H 7/04; H05H 13/04

(57) ABSTRACT

An insertion device includes first and second magnet arrays facing each other with a gap therebetween, magnet supporting members adapted to support the magnet arrays mounted thereto, a gap driving mechanism for driving the first and second magnet supporting members in the vertical direction for changing the gap size, a driving conjunction mechanism for coupling the gap driving mechanism and the magnet supporting members to each other, compensation spring mechanisms adapted to compensate for attractive forces acting on the first and second magnet arrays, a spring conjunction mechanism for coupling the compensation spring mechanisms and the magnet supporting members to each other, a first supporting frame for supporting the gap driving mechanism, a second supporting frame for supporting the compensation spring mechanisms, and a common base placed on a placement surface, wherein the first supporting frame and the second supporting frame are individually coupled to the common base.

### TECHNICAL FIELD

The present invention relates to an insertion device including a first magnet array including a plurality of magnets placed in an array, a first magnet supporting member adapted to support the first magnet array which is mounted to the first magnet supporting member, a second magnet array including a plurality of magnets placed in an array and being faced to the first magnet array with a gap interposed therebetween, a second magnet supporting member adapted to support the second magnet array which is mounted to the second magnet supporting member, a gap driving mechanism for driving the first magnet supporting member and/or the second magnet supporting member in a vertical direction for changing the size of the gap, and a driving conjunction mechanism for coupling the gap driving mechanism and the magnet supporting members to each other.

### BACKGROUND ART

When an electron beam having been accelerated to approximately have the velocity of light in vacuum is bent within a magnetic field, radiation is emitted in tangential directions of the movement locus of the electron beam. This is called synchrotron radiation. There have been made studies for practical applications of various techniques for installing light sources for generating such synchrotron radiation in straight sections of electron storage rings (electron-beam accumulating rings), in order to utilize its properties such as high directivity, high intensity, and high polarization properties. Existing electron storage rings have been provided with plural insertion devices (undulators), as high-brightness light sources having higher beam electric currents and smaller beam cross-sectional areas.

As such insertion devices, there has been known an insertion device disclosed in the following Patent Document 1, for example. This insertion device includes a structure including a first magnet array constituting a plurality of magnets placed in an array, and a second magnet array constituting a plurality of magnets placed in an array, such that the first and second magnet arrays are faced to each other with a gap interposed therebetween. Since the pluralities of magnets are faced to each other as descried above, large attractive forces act between both of them. The actions of these attractive forces degrade precise gap driving and, furthermore, cause deformations of magnet supporting members which support the magnet arrays, which disturbs a magnetic-field intensity distribution in the initially-set magnetic-field generating space (the gap). This has resulted in the problem that synchrotron radiation with desired properties cannot be provided.

In order to overcome this problem, the following Patent Document 2 discloses compensation spring assemblies provided with compensation springs. The compensation springs are provided for the sake of compensating for attractive forces acting between a first magnet array and a second magnet array. In the insertion device, girders for supporting the magnet arrays are driven upwardly and downwardly in the vertical direction, through gap driving mechanisms provided in a primary C-frame structure. The gap driving mechanisms are for changing the size of the gap. Further, the girders for supporting the magnet arrays are supported by secondary C-frame structures with spring assemblies interposed therebetween. The secondary C-frame structures are coupled to the primary C-frame structure in both its right and left sides. These spring assemblies are intended to reduce the loads exerted on the gap driving mechanisms and, also, to suppress the deformation of the girders as the magnet supporting members.

### PRIOR ART DOCUMENTS

### Patent Documents

Patent Document 1: JP-A-2001-143899

Patent Document 2: U.S. Pat. No. 7,956,557 B1

### SUMMARY OF THE INVENTION

### Problems to be Solved by the Invention

However, the structure in the aforementioned Patent Document 2 has problems as follows. Namely, the gap driving mechanisms mounted on the primary C-frame structure are structured to be coupled directly to the compensation spring mechanisms with the secondary C-frame structures interposed therebetween. Therefore, the gap driving mechanisms may be deformed due to repulsive forces from the compensation springs, and this deformation of the gap driving mechanisms may degrade the precise gap control. Accordingly, although this structure is provided with the compensation springs, this structure is not capable of sufficiently exerting the performance thereof.

The present invention was made in view of the aforementioned circumstances and aims at providing an insertion device capable of preventing repulsive forces induced from compensation spring mechanisms from influencing precise gap driving.

In order to solve the above problem, an insertion device according to the present invention comprising:

a first magnet array including a plurality of magnets placed in an array;

a first magnet supporting member adapted to support the first magnet array which is mounted to the first magnet supporting member;

a second magnet array including a plurality of magnets placed in an array and being faced to the first magnet array with a gap interposed between the first magnet array and the second magnet array;

a second magnet supporting member adapted to support the second magnet array which is mounted to the second magnet supporting member;

a gap driving mechanism for driving the first magnet supporting member and/or the second magnet supporting member in a vertical direction for changing a size of the gap;

a driving conjunction mechanism for coupling the gap driving mechanism and the magnet supporting members to each other;

a compensation spring mechanism adapted to act in such a direction as to compensate for an attractive force acting on the first magnet array and the second magnet array;

a spring conjunction mechanism for coupling the compensation spring mechanism and the magnet supporting members to each other;

a first supporting frame for supporting the gap driving mechanism;

a second supporting frame for supporting the compensation spring mechanism; and

a common base placed on a placement surface;

wherein the first supporting frame and the second supporting frame are individually coupled to the common base.

The insertion device having this structure has effects and advantages as follows. The first supporting frame supports the gap driving mechanism, and it is possible to change the size of the gap by driving the magnet supporting members through the driving conjunction mechanism. The second supporting frame supports the compensation spring mechanism and is coupled to the magnet supporting members through the spring conjunction mechanism. The first supporting frame and the second supporting frame are individually coupled to the common base. Namely, the first supporting frame and the second supporting frame are not directly coupled to each other. This prevents repulsive forces generated in the compensation spring mechanism from being transmitted to the gap driving mechanism. As a result, precise gap driving is enabled, without being influenced by repulsive forces in the compensation spring mechanism.

In the present invention, preferably, the first supporting frame includes at least a first vertical frame member and a first horizontal frame member,

the second supporting frame includes at least a second vertical frame member and a second horizontal frame member, and

the first vertical frame member and the second vertical frame member have respective cross-sectional shapes in a horizontal direction which are such shapes that one of the first vertical frame member and the second vertical frame member surrounds the other one.

Since the first supporting frame and the second supporting frame are individually coupled to the common base, it is necessary to effectively utilize the spaces for placing the respective frames therein. Both the first supporting frame and the second supporting frame include vertical frame members. When the vertical frame members in the first supporting frame and the second supporting frame have respective cross-sectional shapes in the horizontal direction which are such shapes that one of their cross-sectional shapes surrounds the other one, the first vertical frame member and the second vertical frame member can be placed at the same position in such a way as to overlap with each other and, also, the first vertical frame member and the second vertical frame member can be placed in such a way as not to come in contact with each other.

In the present invention, preferably, one of the first horizontal frame member and the second horizontal frame member is placed higher or lower than the other one.

By placing the horizontal frame member in the first supporting frame and the horizontal frame member in the second supporting frame in the upward-and-downward direction, it is possible to effectively utilize the spaces for placing the frame members therein.

Preferably, the compensation spring mechanism according to the present invention is mounted on the second horizontal frame member, and the second horizontal frame member is placed in both right and left sides or in one side with respect to the first vertical frame member.

By providing the second horizontal frame member and mounting the compensation spring mechanism thereon, it is possible to place the compensation spring mechanism vertically above or vertically below the magnet supporting members. Further, since the second horizontal frame member is placed in both the right and left sides or in one side with respect to the first vertical frame member, it is possible to effectively utilize the space and, also, it is possible to prevent the second horizontal frame member from coming in contact with the first vertical frame member.

Preferably, the compensation spring mechanism according to the present invention includes at least one coil spring, and a spring-force exerting member for exerting the coil spring in such a direction as to compress the coil spring, and the spring conjunction mechanism has a function of coupling the spring-force exerting member and the magnet supporting members to each other.

More specifically, preferably, the compensation spring mechanism includes at least one coil spring, and a spring-force exerting member which includes a movable plates for exerting the coil spring in such a direction as to compress the coil spring and a pusher held to the movable plate, and the spring conjunction mechanism includes an engagement portion of an engagement member mounted to a coupling rod coupled to the magnet supporting members and engagement surfaces in engagement members mounted to the compensation spring mechanism ,and the spring conjunction mechanism has a function of coupling the spring-force exerting member and the magnet supporting members to each other.

With this structure, there is provided the spring exerting member for exerting the coil spring in such a way as to compress the coil spring, and a repulsive force thereagainst (a force attempting to stretch the coil spring) is exerted on the magnet supporting members. Namely, it is possible to exert a force in the opposite direction from that of attractive forces attempting to cause the magnet arrays faced to each other with the gap interposed therebetween to get closer to each other, which can suppress the deformation of the magnet supporting members due to such attractive forces.

More specifically, the coupling rod is moved due to the change of the gap, which causes the coil spring in the compensation spring mechanism to be compressed through the engagement between the engagement portions.

Further, the coupling between the spring-force exerting member and the magnet supporting members includes a structure for coupling the spring-force exerting member and the magnet supporting members to each other with another member interposed therebetween, as well as a structure for directly coupling them to each other.

Preferably, the compensation spring mechanism according to the present invention includes a plurality of coil springs, and includes a spring-force adjustment mechanism for adjusting spring forces of the respective coil springs.

More specifically, preferably, the compensation spring mechanism according to the present invention includes a plurality of coil springs, and includes a spring-force adjustment mechanism for adjusting spring forces of the respective coil springs, wherein the spring-force adjustment mechanism is constituted by pushers held by the movable plate, and spring caps faced to pushing portions of the pushers.

By providing the plural coil springs, it is possible to exert a proper spring force, through the placement and the number of the springs. Further, since the spring forces of the respective coil springs are made adjustable, it is possible to appropriately set the spring force, in consideration of variations among the members.

More specifically, the spring forces of the coil springs are individually adjusted, by pushing the spring caps inserted to the upper ends of the coil springs through the pushing portions of the pushers.

In the present invention, preferably, the driving conjunction mechanism is placed vertically above or vertically below the gap.

More specifically, preferably, the driving conjunction mechanism is constituted by a first coupling shaft coupled to the magnet supporting members, a second coupling shaft coupled to the first coupling shaft, and an LM guide supporting member coupled to the second coupling shaft, and the driving conjunction mechanism is provided vertically above or vertically below the gap.

In this case, “the driving conjunction mechanism is provided vertically above or vertically below the gap” indicates that the driving conjunction mechanism is provided vertically above or vertically below the plane in which the first magnet array and the second magnet array, which form the gap therebetween, are faced to each other. Further, the coupling structures include not only structures for directly coupling the members to each other, but also structures for coupling them to each other with another member interposed therebetween.

With this structure, it is possible to suppress the deformation of the driving conjunction mechanism due to the effect of attractive forces. Namely, in the structure according to Patent Document 1 and other structures, a ball screw which forms a driving conjunction mechanism exists at a position spaced apart from the gap in the horizontal direction. Therefore, the fulcrum (the ball screw) and the point of action (the gap) are spaced apart from each other, so that the fulcrum is liable to be deformed due to the principle of leverage. On the other hand, when the driving conjunction mechanism is positioned in the vertical direction with respect to the gap, namely vertically above or vertically below the gap, as in the present invention, the driving conjunction mechanism can be positioned closer to the gap, so that the fulcrum and the point of action are at a shorter distance from each other, which can suppress the deformation at the fulcrum.

In the present invention, preferably, the compensation spring mechanism is provided for only one of the first magnet supporting member and the second magnet supporting member,

the second supporting frame includes a frame main body portion, a first supporting portion, and a second supporting portion,

the compensation spring mechanism is installed on the first supporting portion,

the other one of the first magnet supporting member and the second magnet supporting member, for which the compensation spring mechanism is not provided, is secured to the second supporting portion and, further, includes a frame guide mechanism for guiding movement of the second supporting frame in vertically upward and downward directions, and

the second supporting frame is placed on the common base with the frame guide mechanism interposed between the second supporting frame and the common base.

With this structure, the second supporting frame is constituted by the frame main body, the first supporting portion and the second supporting portion. The compensation spring mechanism is provided only for one of the first magnet supporting member and the second magnet supporting member. When the gap is made smaller by δ, in cases where the compensation spring mechanisms are provided for both the first and second magnet supporting members, the spring in each compensation spring mechanism is shrunk by δ/2. On the other hand, in cases where the compensation spring mechanism is provided for only one of them, the spring in the compensation spring mechanism is shrunk by δ. Generally, the spring is operated more stably when the spring is shrunk by a larger amount. Further, since the compensation spring mechanism is provided only for one of the first magnet supporting member and the second magnet supporting member, it is possible to provide an advantage in terms of the cost.

The other one of the first magnet supporting member and the second magnet supporting member, for which the compensation spring mechanism is not provided, is secured to the second supporting portion. Accordingly, when the size of the gap is changed, it is necessary to move the second supporting frame, along with the movement of the other one of the magnet supporting members. For coping therewith, a frame guide mechanism can be provided on the second supporting frame (the frame main body portion and/or the supporting portions), in order to move the second supporting frame integrally with the magnet supporting member.

Preferably, the compensation spring mechanism according to the present invention is provided for only one of the first magnet supporting member and the second magnet supporting member,

the second supporting frame includes a frame main body portion, a first supporting portion, and a second supporting portion,

the compensation spring mechanism is installed on the first supporting portion, and

the other one of the first magnet supporting member and the second magnet supporting member, for which the compensation spring mechanism is not provided, is secured to the second supporting portion and, further, includes a supporting-portion guide mechanism for guiding movement of the first supporting portion and the second supporting portion in vertically upward and downward directions, with respect to the frame main body portion.

With this structure, the second supporting frame is constituted by the frame main body, the first supporting portion and the second supporting portion. The compensation spring mechanism is provided only for one of the first magnet supporting member and the second magnet supporting member. Accordingly, when the gap is made smaller by δ, the spring in the compensation spring mechanism is also shrunk by δ, as described above. Thus, the spring can be shrunk by a larger amount and, therefore, can be stabilized in operation. Further, since the compensation spring mechanism is provided only for one of the first magnet supporting member and the second magnet supporting member, it is possible to provide an advantage in terms of the cost.

The other one of the first magnet supporting member and the second magnet supporting member is secured to the second supporting portion. Accordingly, when the size of the gap is changed, it is necessary to move the first supporting portion and the second supporting portion, along with the movement of the other one of the magnet supporting members. For coping therewith, a supporting-portion guide mechanism for guiding the first supporting portion and the second supporting portion with respect to the frame main body portion can be provided, in order to integrally move these supporting portions and the magnet supporting member.

In the present invention, preferably, there is provided a coupling member for coupling the first supporting portion and the second supporting portion to each other.

With this structure, the first supporting portion and the second supporting portion can be integrated with each other through the coupling member, which enables smoothly moving the first supporting portion and the second supporting portion in the vertical direction in changing the gap.

In the present invention, preferably, there is provided a supporting elastic member for supporting the second supporting frame on the common base.

By providing the supporting elastic member, it is possible to properly support the entirety or a portion of the second supporting frame with a weight.

### BRIEF DESCRIPTION OF THE DRAWINGS

FIG. 1 is a view illustrating a front view of an insertion device according to a first embodiment.

FIG. 2 is a C-C cross-sectional view regarding FIG. 1.

FIG. 3 is an A-A cross-sectional view regarding FIG. 2.

FIG. 4 is a rear-side perspective view illustrating the insertion device in a state where only a second supporting frame has been detached.

FIG. 5A is a front-side perspective view illustrating the insertion device in a state where only the second supporting frame has been detached.

FIG. 5B is a perspective view of the external appearance of the insertion device.

FIG. 5C is a perspective view of the insertion device at its bottom surface.

FIG. 6 is a longitudinal cross-sectional view illustrating the structure of a gap driving mechanism for moving a magnet supporting member upwardly and downwardly.

FIG. 7 is a longitudinal cross-sectional view illustrating a conjunction mechanism for compensation spring mechanisms and the magnet supporting member.

FIG. 8 is a perspective view illustrating the structures around the compensation spring mechanisms.

FIG. 9A is a perspective view illustrating the structure of a compensation spring mechanism.

FIG. 9B is a front view illustrating the structure of the compensation spring mechanism.

FIG. 9C is a longitudinal cross-sectional view illustrating the structure of the compensation spring mechanism.

FIGS. 10A is a side view illustrating the structure of a vertical frame member.

FIG. 10B is a vertical cross-sectional view illustrating the structure of the vertical frame member.

FIG. 10C is a horizontal cross-sectional view illustrating the structure of the vertical frame member.

FIG. 10D is a horizontal cross-sectional view illustrating the structure of a vertical frame member according to another embodiment.

FIG. 11A is a schematic view illustrating the structure of an insertion device according to a second embodiment.

FIG. 11B is a schematic view illustrating the structure of the insertion device according to the second embodiment.

FIG. 12A is a front view illustrating the structure of the insertion device according to the second embodiment.

FIG. 12B is aside view illustrating the structure of the insertion device according to the second embodiment.

FIG. 13A is a schematic view illustrating the structure of an insertion device according to a third embodiment.

FIG. 13B is a schematic view illustrating the structure of the insertion device according to the third embodiment.

FIG. 13C is a view illustrating changing of a gap center line in the insertion device according to the third embodiment.

FIG. 14A is a front view illustrating the structure of the insertion device according to the third embodiment.

FIG. 14B is aside view illustrating the structure of the insertion device according to the third embodiment.

### MODE FOR CARRYING OUT THE INVENTION

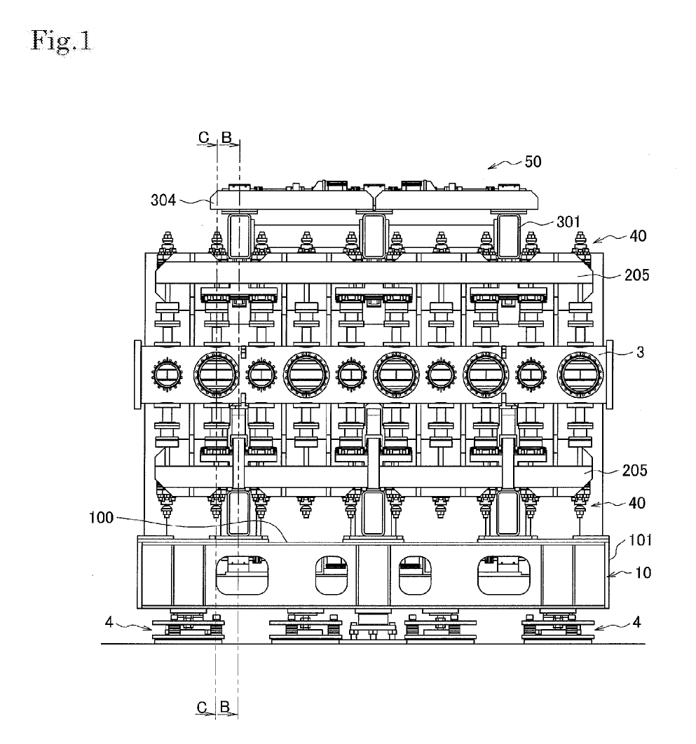

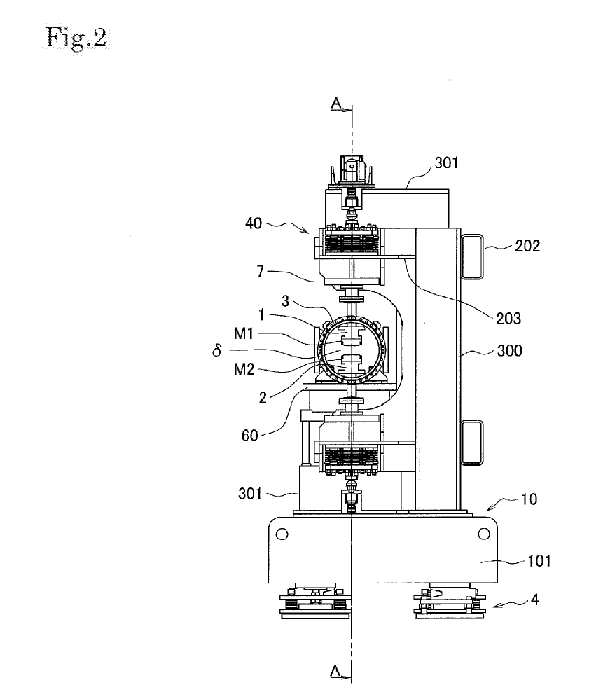

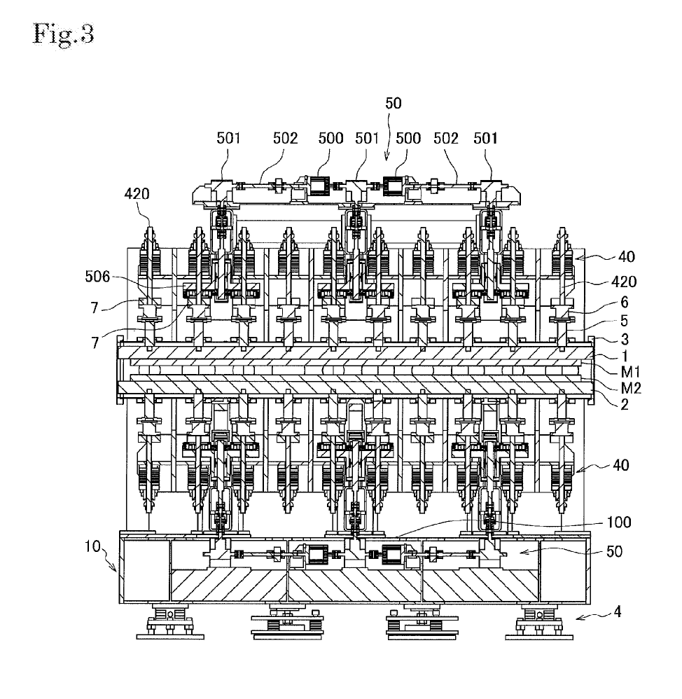

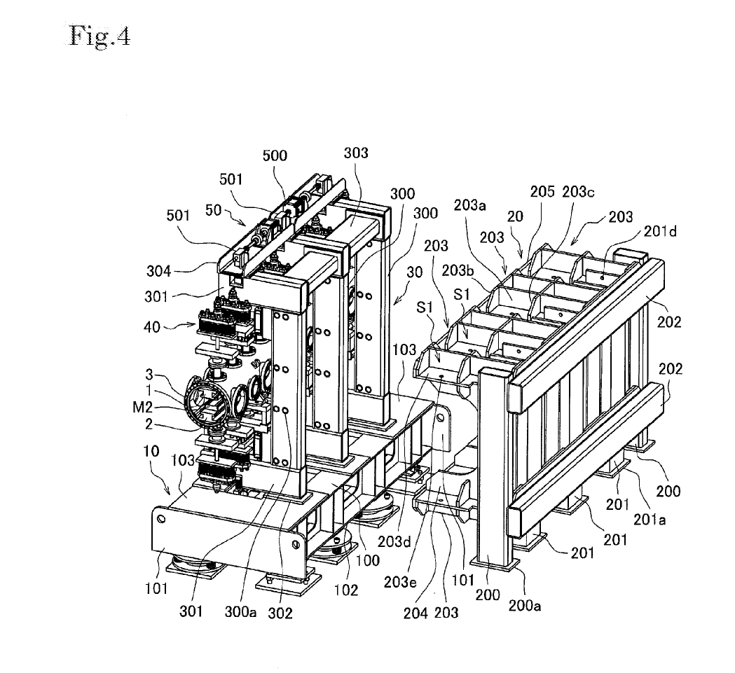

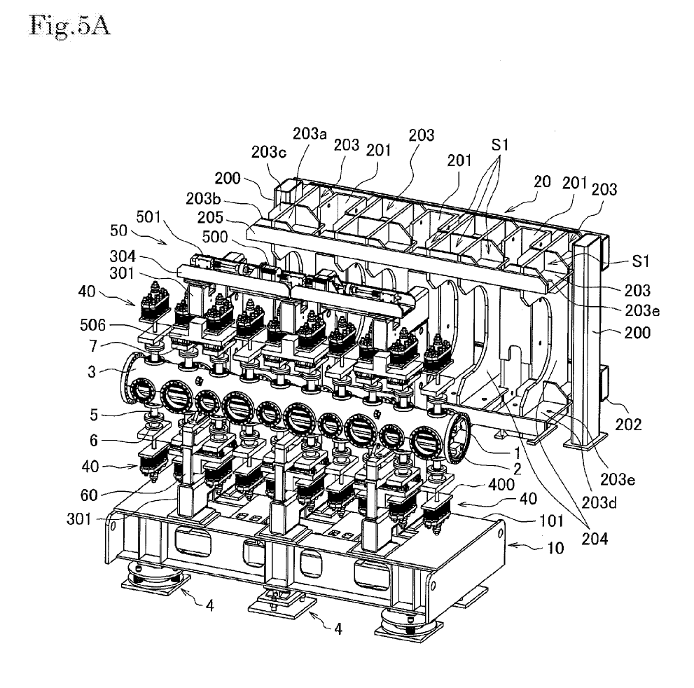

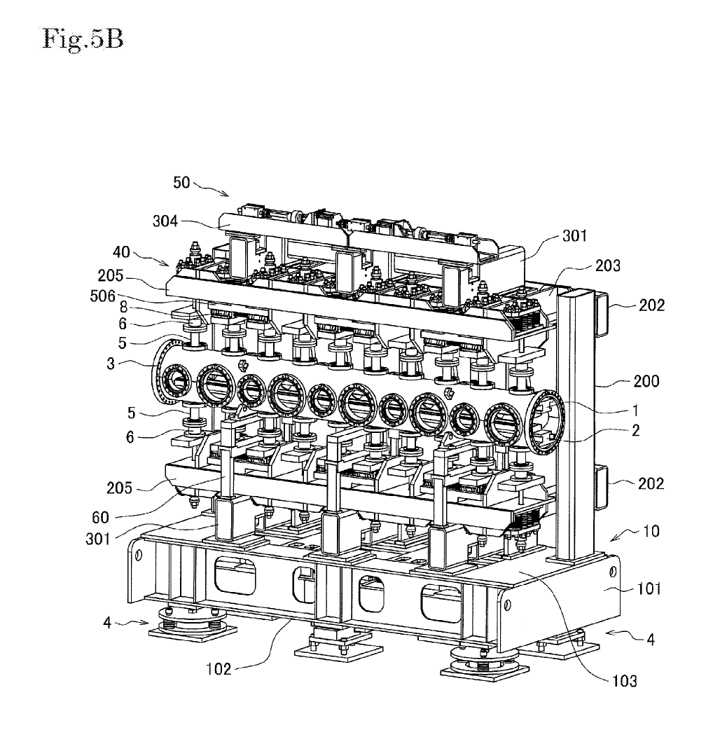

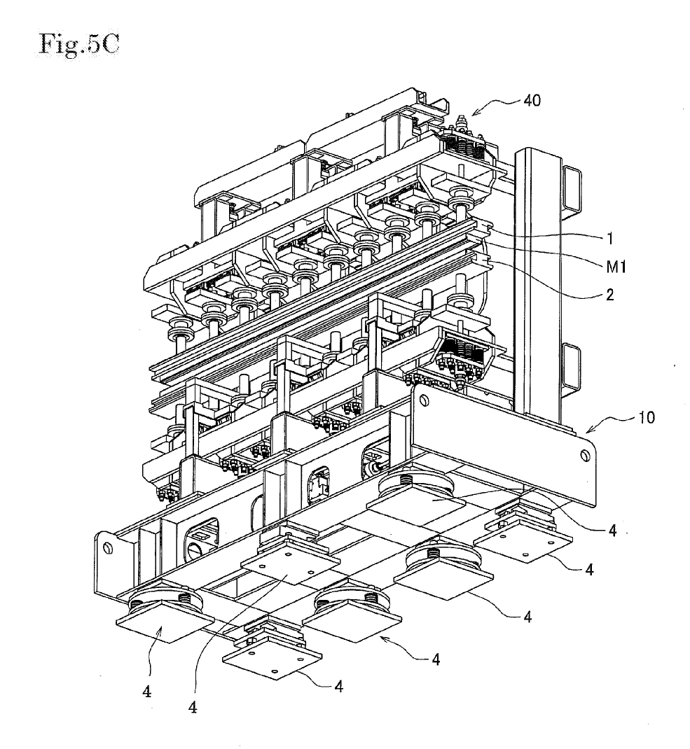

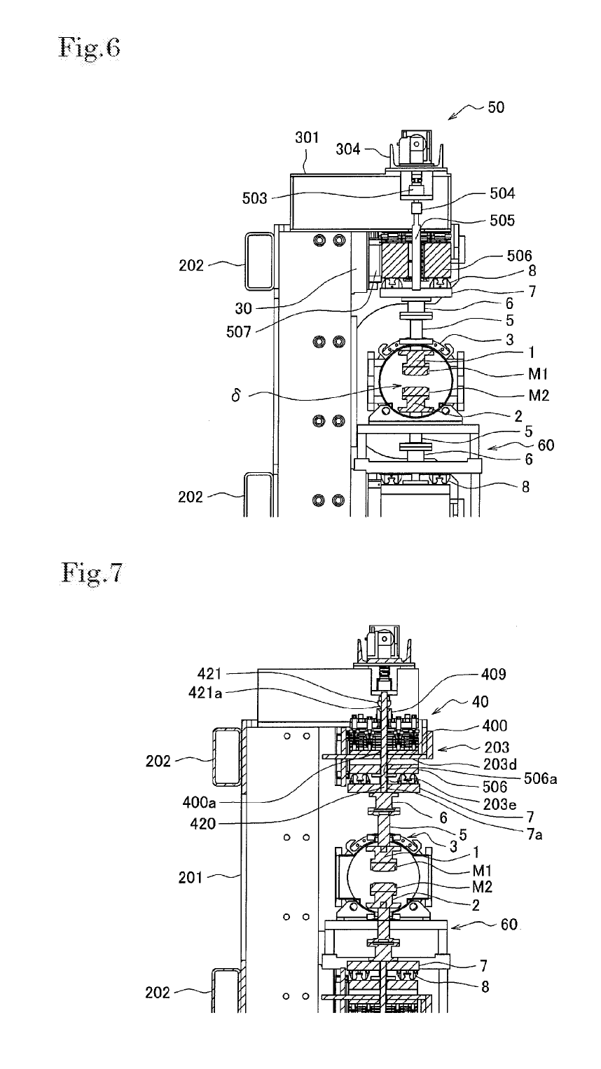

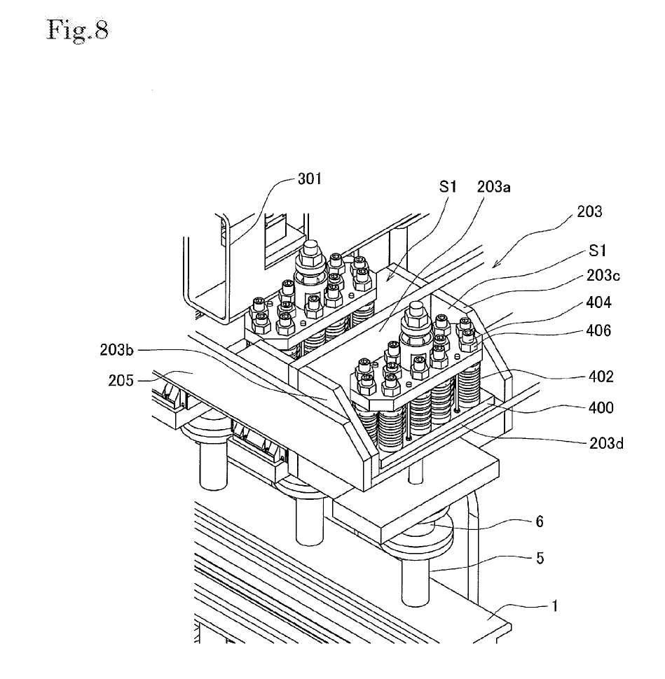

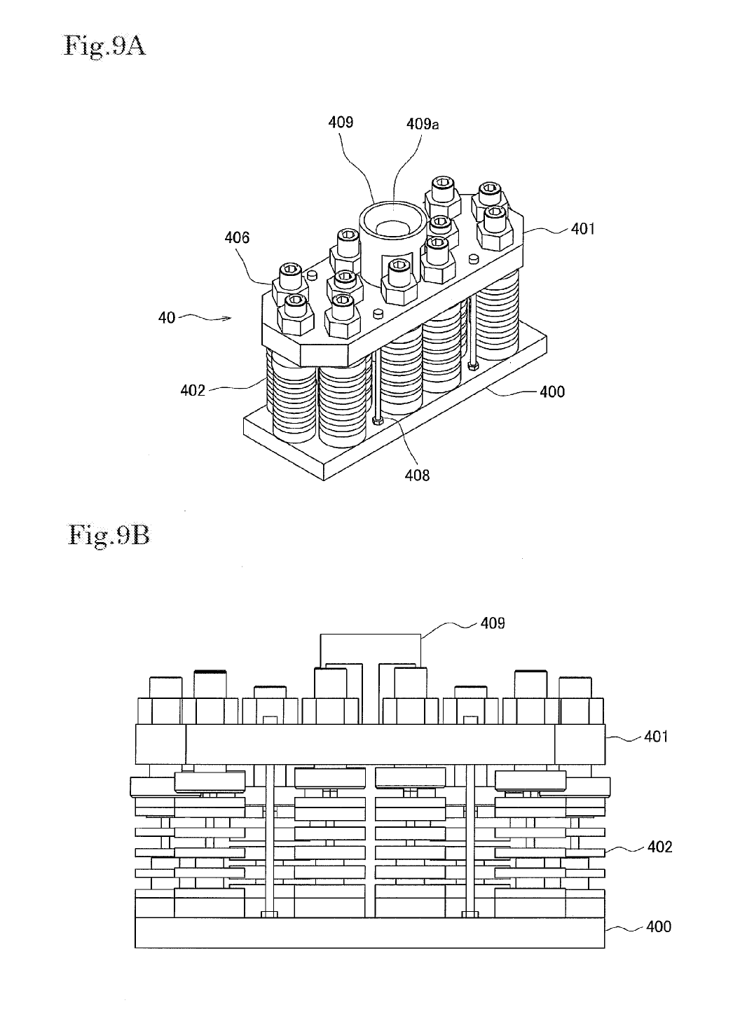

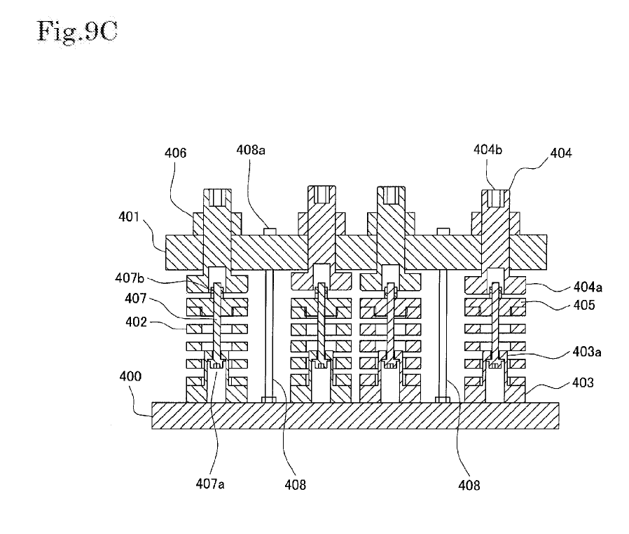

A preferable embodiment (a first embodiment) of an insertion device according to the present invention will be described, with reference to the drawings. FIG. 1 is a view illustrating a front view of the insertion device according to the present embodiment. FIG. 2 is a C-C cross-sectional view regarding FIG. 1. FIG. 3 is an A-A cross-sectional view regarding FIG. 2. FIG. 4 is a rear-side perspective view illustrating the insertion device in a state where only a second supporting frame for supporting compensation spring mechanisms has been detached. FIG. 5A is a front-side perspective view illustrating the insertion device in a state where only the second supporting frame has been detached. FIG. 5B is a perspective view of the same in an assembled state. FIG. 5C is a perspective view of the insertion device at its bottom surface. FIG. 6 is a longitudinal cross-sectional view (a B-B cross section regarding FIG. 1) illustrating the structure of a gap driving mechanism for moving a magnet supporting member upwardly and downwardly. FIG. 7 is a longitudinal cross-sectional view (a C-C cross section regarding FIG. 1) illustrating a driving conjunction mechanism for a compensation spring mechanism and the magnet supporting member. FIG. 8 is a perspective view illustrating the structures around compensation spring mechanisms. FIG. 9 is a view illustrating the structure of a compensation spring mechanism, wherein FIGS. 9A, 9B and 9C are a perspective view, a front view and a longitudinal cross-sectional view of the same, respectively.

In the insertion device, a first magnet array M1 including a plurality of magnets placed in an array, and a second magnet array M2 including a plurality of magnets placed in an array, similarly, are opposed to each other with a gap δ interposed therebetween. An electron beam passes through this gap space. Further, as the magnet arrays, it is possible to employ various examples of structures, such as one exemplified as Patent Document 1, and one disclosed in No. JP-A-2014-13658, for example. Accordingly, the magnet arrays are not limited to particular placement of magnets.

The first magnet array M1 is supported by a first magnet supporting member M, and the second magnet array M2 is supported by a second magnet supporting member M. For example, each of the magnets constituting the first magnet array M1 is coupled to the first magnet supporting member M, through bolts and the like. The same applies to the second magnet array M2.

The first magnet array M1 and the second magnet array M2 are installed inside a vacuum vessel 3 which is interiorly maintained in ultra-high vacuum. The vacuum vessel 3 has a cross section with a cylindrical shape and has an elongated shape along the rightward-and-leftward direction in the figures (in the direction of propagation of the electron beam), as illustrated in FIGS. 1 and 3. Further, the gap 5 can be changed in size through gap driving mechanisms, which will be described later. A common base 10 is placed on a placement surface through three pedestals 4 in the front side and four pedestals 4 in the rear side and, therefore, a total of seven pedestals 4 (see FIGS. 1 to 4, and particularly FIG. 5C).

Further, the vacuum vessel 3 is supported on the common base 10 by supporting members 60 with first horizontal frame members 301 interposed therebetween. As illustrated in FIGS. 5A and 5B, the lower portions of the supporting members 60 are installed on the first horizontal frame members 301, which are installed on the common base 10, and are coupled thereto through mechanical means which is not illustrated.

The common base 10 includes an upper-surface plate 100, a pair of right and left side-surface plates 101, and a lower-surface plate 102. The pedestals 4 are provided under the lower-surface plate 102. On the upper-surface plate 100, there are further provided reinforcing upper-surface plates 103 at three positions.

The first supporting frame 30 is a frame for supporting the gap driving mechanisms for changing the gap δ. The second supporting frame 20 is a frame for supporting the compensation spring mechanisms. Each of the frames is constituted by a plurality of frame members.

As illustrated in FIG. 4, the second supporting frame 20 includes second vertical frame members 200 and 201. The second supporting frame 20 includes the second vertical frame members 200 positioned at the opposite end portions, and the three second vertical frame members 201 positioned therebetween. The second vertical frame members 200 have a cross section with a rectangular shape which is taken along a horizontal plane. The second vertical frame members 201 have a cross section with a tubular-rectangular shape or a C shape which is taken along a horizontal plane. This point will be described in detail later. The second vertical frame members 200 and 201 include leg portions 200a and 201a at their lower end portions, and these leg portions 200a and 201a are coupled to the reinforcing upper-surface plates 103 in the common base 10, through mechanical means such as bolts.

The second supporting frame 20 is provided, in its rear side, with a pair of reinforcement frames 202 extending in the rightward-and-leftward direction, in the upper and lower sides. These reinforcement frames 202 have a cylindrical shape with a rectangular cross section and are coupled to the five second vertical frame members 200 and 201 through bolts, welding or other methods.

The second supporting frame 20 is provided, in its front side, with second horizontal frame members 203. The second horizontal frame members 203 are provided above and below the vacuum vessel 3, and C-shaped reinforcement frames 204 are provided between the upper and lower second horizontal frame members 203 (see FIGS. 4 and 5A). The second horizontal frame members 203 are provided, at their tip ends, with placement spaces S1 for mounting the compensation spring mechanisms 40 therein. The placement spaces S1 are provided at ten positions according to the number of the compensation spring mechanisms 40. Further, in FIGS. 4 and 5A, the second supporting frame 20 is illustrated separately from the compensation spring mechanisms 40, in order to make it easier to understand the structure of the second supporting frame 20. The compensation spring mechanisms 40 are placed at 10 positions in each of the upper and lower sides and, therefore, are provided at 20 positions in total. Further, the number of the compensation spring mechanisms 40 placed therein can be determined as required.

For forming the placement spaces S1, the second horizontal frame members 203 include a wall-surface plate 203a extending in the forward-and-rearward direction, and wall-surface plates 203b and 203c extending in the rightward-and-leftward direction. Further, the second horizontal frame members 203 are provided with a bottom-surface plate 203d for placing compensation spring mechanisms 20 thereon. The compensation spring mechanisms 40 are secured to the placement spaces S1 surrounded by these wall-surface plates 203a, 203b, 203c and 203d. Further, the bottom-surface plate 203d is provided with a hole 203e, substantially at the center thereof. This hole 203e is a hole for penetrating a coupling rod 420 therethrough and will be described in detail later.

As illustrated in FIGS. 4 and 5A, there are the four second horizontal frame members 203 extending in such a way as to protrude from the rear side toward the front side. The second horizontal frame members 203 in both the right and left sides are enabled to mount two compensation spring mechanisms 40 thereon, while the two second horizontal frame members 203 at the center are each enabled to mount three compensation spring mechanisms 40 thereon. The three first vertical frame members 300 are assembled in such away as to be interposed between these four second horizontal frame members 203. Accordingly, the second horizontal frame members 203 are adapted to be placed in both the right and left sides or in one side with respect to the first vertical frame members 300. Coupling frames 205 are provided on the front sides of the four second horizontal frame members 203, in order to provide reinforcement for preventing the second horizontal frame members 203 from deforming at their front sides.

The first supporting frame 30 is for supporting the gap driving mechanisms 50 and includes the three first vertical frame members 300. The first vertical frame members 300 are formed to have a cylindrical shape and have a cross section with a rectangular shape, which is taken along a horizontal plane. First horizontal frame members 301 are provided on the upper and lower portions of the first vertical frame members 300. Leg portions 302 are provided on the bottom surfaces of the first horizontal frame members 301 in the lower side, and the first supporting frame 30 is coupled to the common base 10 with these leg portions 302 interposed therebetween, through mechanical means such as bolts. It is preferable that the first horizontal frame members 301 are supported by the leg portions 302, in order to suppress flections of the gap driving mechanisms.

In the rear side, there is provided a coupling frame member 303 for coupling the first horizontal frame members 301 in the upper side to each other. The first horizontal frame members 301 extend in the forward-and-rearward direction. On the front sides thereof, there is provided a coupling frame member 304 for mounting a gap driving mechanism 50 therein. The coupling frame member 304 in the front side has a C-shaped cross section having an opened upper portion. Further, the coupling frame member 304 in the front side is coupled to the upper sides of the first horizontal frame members 301.

As illustrated in FIG. 4, the first horizontal frame members 301 in the upper side are placed higher than the second horizontal frame members 203. This enables effective utilization of the placement spaces, in such a way as to prevent them from interfering (contacting) with each other. Further, regarding the positional relationship therebetween in the upward and downward direction, they can be placed in the opposite manner.

### The Structure of the Vertical Frame Members

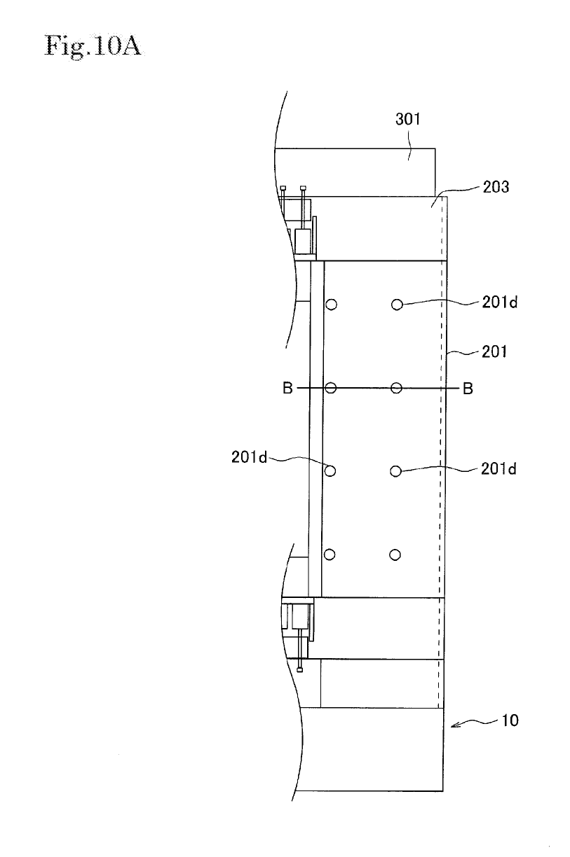

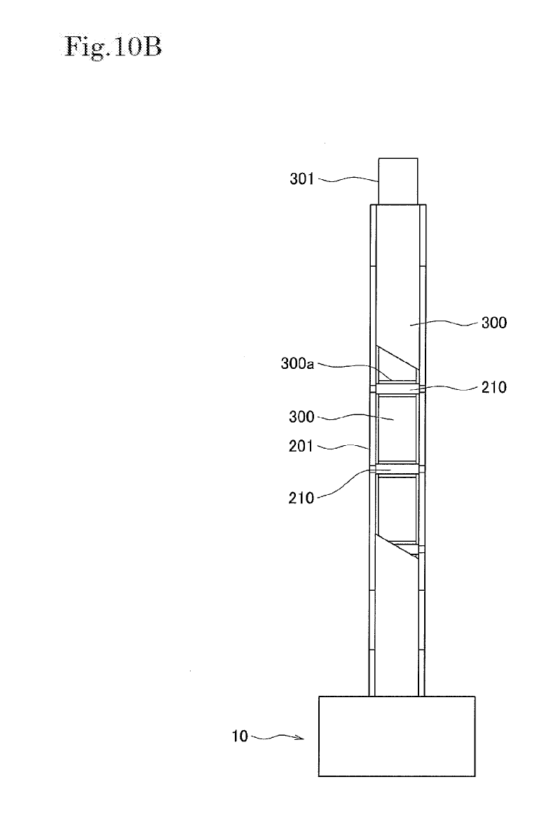

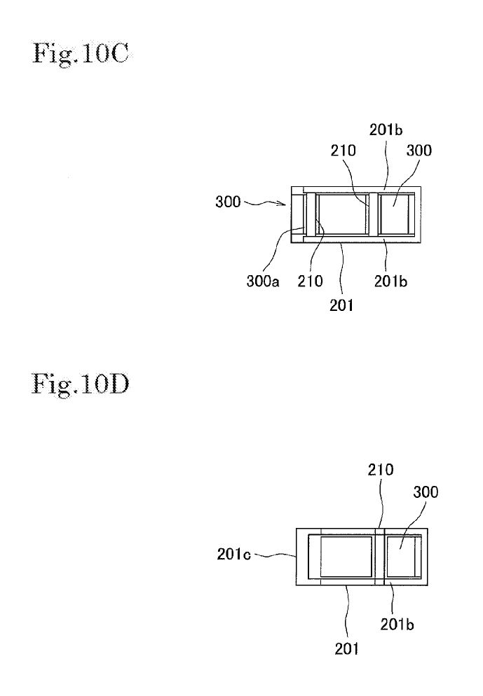

Further, the first vertical frame members 300 and the second vertical frame members 201 are placed at the same positions and are coupled to the common base 10. In this case, preferably, they are placed in such a way as to be prevented from interfering (contacting) with each other. FIGS. 10A, 10B and 10C are views illustrating the structure of the vertical frame members. FIG. 10B illustrates a first vertical frame member 300 in a state where its rear side is partially cut away. FIG. 10C is a B-B cross-sectional view regarding FIG. 10A.

As illustrated in FIG. 4, the first vertical frame members 300 are provided with holes 300a at four positions in the upward and downward direction. At positions corresponding thereto, the second vertical frame members 201 are provided with holes 201d. As illustrated in FIG. 10C, the first vertical frame members 300 have a rectangular-shaped cross section taken along a horizontal direction. In such away as to surround them, the second vertical frame members 201 are placed. The second vertical frame members 201 have a substantially-C-shaped cross section taken along a horizontal direction.

Further, coupling shafts 210 are provided between wall surfaces 201b of each second vertical frame member 201 which are opposed to each other. These coupling shafts 210 are placed at positions corresponding to the aforementioned holes 300a and the holes 201d. In FIG. 10C, as a most preferable embodiment, the interval between the wall surfaces 201b is maintained, and the wall surfaces 201b are prevented from coming in contact with the first vertical frame member 300. The coupling shafts 210 are mounted at two positions in the front and rear sides, as illustrated in FIG. 10C. As described above, the first supporting frame 30 and the second supporting frame 20 are adapted such that they do not come in direct contact with each other. Further, the first supporting frame 30 and the second supporting frame 20 are structured to be coupled to each other indirectly through only the common base 10. Thus, even if the compensation spring mechanisms 40 mounted on the second supporting frame 20 are deformed due to attractive forces of the magnets in the magnet arrays, this deformation is prevented from being transmitted to the gap driving mechanisms mounted on the first supporting frame 30.

FIG. 10D is a view illustrating another embodiment. A coupling shaft 210 is provided only at a single position in the forward and rearward direction. Each second horizontal frame member 201 is provided with a closing plate 201c on the front side thereof, so that it has a rectangular-shaped cross-section in entirety. With this structure, the first vertical frame members 300 and the second vertical frame members 201 are prevented from coming in direct contact with each other.

### The Gap Driving Mechanisms

There will be described the gap driving mechanisms 50 for changing the size of the gap δ. On the coupling frame member 304 in the first supporting frame 30, there are provided motors 500 as driving sources, and conversion portions 501. The motors 500 are placed at two positions, and the conversion portions 501 are placed at three positions. The rotations of the motors 500 are transmitted to the conversion portions 501 through horizontal shafts 502, and the conversion portions 501 convert the rotations about the horizontal shafts into rotations about vertical shafts. More specifically, the conversion portions 501 are constituted by bevel gears and the like.

As illustrated in FIG. 6, the rotations about the vertical shafts, which have been resulted from the conversions, are transmitted to rotational screws 505 forming ball screw mechanisms, through reduction gears 503, and couplings 504. The rotations of the rotational screws 505 cause supporting members 506 to perform rectilinear motions in the upward and downward directions. There are provided vertical LM guides 507 for guiding the supporting members 506. The vertical LM guides 507 are mounted to a member constituting the first supporting frame 30. Accordingly, the supporting members 506 can be moved upwardly and downwardly, by driving the motors 500.

A first magnet supporting member 1 which supports the first magnet array M1 is coupled to LM guide supporting members 7 with first coupling shafts 5, and second coupling shafts 6 interposed therebetween. These plural members are firmly coupled to each other through mechanical means such as bolts and nuts. Further, horizontal LM guides 8 are coupled to the LM guide supporting members 7. Accordingly, if the supporting members 506 are moved upwardly and downwardly, the LM guide supporting members 7, the second coupling shafts 6, the first coupling shafts 5, the first magnet supporting member 1 and the first magnet array M1 are moved upwardly and downwardly, integrally therewith. As a result, the size of the gap δ can be changed. Further, a gap mechanism 50 for moving the second magnet array M2 upwardly and downwardly is provided, similarly, but is not described herein since it has the same structure. Further, the first coupling shafts 5, the second coupling shafts 6, and the LM guide supporting members 7 correspond to a driving conjunction mechanism for coupling the gap driving mechanism 50 to the magnet supporting member.

The horizontal LM guides 8 are provided for absorbing the change of the length of the first magnet supporting member 1, when the first magnet supporting member 1 is changed in length in the horizontal direction due to thermal expansion thereof. Accordingly, the gap driving mechanism 50 and the driving conjunction mechanism are prevented from being influenced by such thermal expansion.

As illustrated in FIG. 3, the supporting members 506 have an inverted-T shape in a front view. The supporting members 506 are provided at their vertical portions with ball screw mechanisms, and these vertical portions are guided by the vertical LM guides 507. The horizontal LM guides 8 are mounted to the back surfaces of the horizontal portions of the supporting members 506.

In the aforementioned structure, the ball screw mechanisms, and the first coupling shafts 5, the second coupling shafts 6 and the LM guide supporting members 7, which form the driving conjunction mechanism, are positioned vertically above the gap δ. Namely, it is possible to suppress the deformations of the gap driving mechanism 50 and the driving conjunction mechanism, since they are placed vertically above the gap δ, which is acted by the attractive forces. The same applies to the gap driving mechanism 50 under the gap δ.

### The Structure of the Compensation spring Mechanisms

FIGS. 9A, 9B and 9C are views illustrating the structure of the compensation spring mechanisms 40 in detail. FIG. 8 is an enlarged perspective view illustrating compensation spring mechanisms 40 in a mounted state. As illustrated in FIGS. 9A, 9B and 9C, the compensation spring mechanisms 40 includes a securing plate 400 in a lower side, a movable plate 401 in an upper side, and 12 coil springs 402 placed between the securing plate 400 and the movable plate 401. The coil springs 402 are installed at their lower ends in spring securing seats 403. Each spring securing seat 403 has a protruding portion 403a at its center portion, and each coil spring 402 is installed in such a way as to be inserted thereto. A spring cap 405 is inserted onto the upper end of each coil spring 402. Each compensation spring mechanism 40 is installed in a placement space S1, and the securing plate 400 is secured to the bottom-surface plate 203d in the second horizontal frame member 203 through a method which is not illustrated.

A pusher 404 is placed on the upper end of each coil spring 402. The pusher 404 is provided at its lower end portion with a pushing portion 404a with a larger diameter, which is positioned near the back surface of the movable plate 401. The pusher 404 is provided with a hexagonal hole 404b in its upper end, which enables inserting a hexagonal wrench for adjustment therein. A nut 406 is fitted to a smaller-diameter portion of the pusher 404, so that the pusher 404 is held to the movable plate 401. The pushing portion 404a of the pusher 404 and the spring cap 405 are just faced to each other. The pusher 404 and the spring cap 405 correspond to a spring-force adjustment mechanism.

A spring guide pin 407 is provided in each coil spring 402. The spring guide pin 407 has a lower end portion with a slightly-larger diameter (a larger-diameter portion 407a), which is positioned inside the protruding portion 403a of the spring securing seat 403 and is restricted in terms of upward movement. A nut 407b is fitted to the upper end of the spring guide pin 407, which restricts the upward movement of the spring cap 405. Thus, the coil spring 402 is maintained in a state of being compressed by a predetermined amount. Further, the pushing portion 404a is provided with a recessed portion, in order to enable placing the nut 407b therein.

There are provided four guide pins 408, between the securing plate 400 and the movable plate 401. The guide pins 408 are screwed at their lower ends into the securing plate 400 and are penetrated at their upper ends through the movable plate 401, and nuts 408a are secured to the respective upper ends of the guide pins 408 on the upper surface of the movable plate 401. This restricts the upward movement of the movable plate 401. However, the movable plate 401 is allowed to move downwardly along the guide pins 408.

As illustrated in FIG. 9A, an engagement member 409 is provided on the movable plate 401. The engagement member 409 has an engagement surface 409a formed from a conical surface. By pushing the engagement surface 409a downwardly, it is possible to push the movable plate 401 downwardly.

### The Spring Conjunction Mechanism for the Compensation spring Mechanisms and the Magnet Supporting Member

FIG. 7 illustrates a spring conjunction mechanism for coupling the compensation spring mechanisms 40 and the first magnet supporting member 1 to each other. The coupling rods 420 are coupled integrally to the second coupling shafts 6. An engagement member 421 is mounted to the upper end of each coupling rod 420. The engagement member 421 is provided with an engagement surface 421a formed from a conical surface. These engagement surfaces 421a can be engaged with the engagement surfaces 409a in the engagement members 409 in the compensation spring mechanisms 40.

Further, each securing plate 400 is provided with a hole 400a, and each bottom-surface plate 203 is provided with a hole 203e, in order to penetrate each coupling rod 420 therethrough. Further, each supporting member 506 and each LM guide supporting member 7 are also provided with a hole 506a and a hole 7a, respectively. Preferably, the sizes of the respective holes are determined, in such a way as to prevent the coupling rods 420 from coming in contact with the series of these holes.

### Adjustments of the Compensation springs

Hereinafter, there will be described adjustments of the coil springs 402 in the compensation spring mechanisms 40. At first, the individual coil springs 402 are adjusted. By rotating the pushers 404, the pushing portions 404a are lowered downwardly, and the pushing portions 404a are brought into contact with the spring caps 405, which exerts the spring forces. As described above, in taking account of variations among the respective coil springs 402, it is possible to perform proper adjustments thereof.

### Gap Changing Operations

There will be described operations for changing the gap δ. The first magnet supporting member 1 is moved downwardly, through the gap driving mechanism 50. When the first magnet supporting member 1 is moved downwardly, the first coupling shafts 5, the second coupling shafts 6 and the coupling rods 420 are also downwardly moved integrally therewith. When the coupling rods 420 is lowered, the engagement surfaces 421a of the engagement members 421 are engaged with the engagement surfaces 409a of the engagement members 409 in the compensation spring mechanisms 40, thereby downwardly pushing the engagement surfaces 409a. This lowers the movable plates 401 downwardly, which exerts the coil springs 402 in the direction of compression, through the pushers 404. Accordingly, the movable plates 401 and the pushers 404 correspond to a spring-force exerting member for exerting the coil springs 402 in the direction of compression. The coil springs 402 have load characteristics (spring characteristics) with excellent linearity. Therefore, by exerting the coil springs 402 in the direction of compression through the aforementioned spring-force exerting member, it is possible to secure safety against overloads. Further, the coupling rods 420, and the engagement members 421 and 409 correspond to the spring conjunction mechanism for coupling the spring-force exerting member and the magnetic supporting member to each other.

As the gap δ is made smaller, the coupling rods 402 are more largely lowered in the downward direction, and the spring forces of the coil springs 402 which are exerted in such a direction as to compress the coil springs 402 are made larger. As the gap δ is made smaller, the attractive forces from the magnets are made larger and, in conjunction therewith, the spring forces of the coil springs 402 in the compensation spring mechanisms are made larger. If the attractive forces are made larger, this exerts forces which attempt to deform the magnet supporting members which support the magnet arrays. If the magnet supporting members are deformed, the size of the gap δ is made inconstant, which makes it impossible to maintain an initially-set magnetic-field intensity distribution. Therefore, the compensation spring mechanisms 40 are provided, in order to suppress the deformation of the magnet supporting members due to attractive forces.

In aforementioned description, there has been described the mechanism for coupling the compensation spring mechanisms 40 and the first magnet supporting member 1 to each other. However, as illustrated in FIG. 3, the second magnet supporting member 2 and compensation spring mechanisms 40 are also coupled to each other. Accordingly, when the size of the gap δ is adjusted, at least one of the first magnet supporting member 1 and the second magnet supporting member 2 is driven upwardly or downwardly. No matter which of them is driven upwardly or downwardly, the compensation spring mechanisms 40 are exerted.

Due to the actions of attractive forces, forces are exerted in such a way as to attempt to deform the gap driving mechanisms and the driving conjunction mechanisms. Even if the compensation spring mechanisms 40 are deformed, this deformation is prevented from influencing the gap driving mechanisms and the driving conjunction mechanisms. Namely, the first supporting frame 30 which supports the gap driving mechanisms 50 and the second supporting frame 20 which supports the compensation spring mechanisms 40 are individually coupled to the common base 10, which prevents repulsive forces induced in the compensation spring mechanisms from influencing the precise gap driving.

### Other Embodiments

The structures of the first and second supporting frames 20 and 30 are not limited to those according to the present embodiment. For example, the numbers and the shapes of the vertical frame members can be changed as required.

In the present embodiment, the gap driving mechanisms 50 are provided for both the first magnet supporting member 1 and the second magnet supporting member 2, so that both of them can be driven upwardly and downwardly. However, the present invention is not limited thereto. The gap driving mechanism 50 can be also provided for only one of them.

In the present embodiment, the first supporting frame 30 and the second supporting frame 20 are adapted to have the vertical frame members which are placed in rows in such a way as to overlap with each other toward the vacuum vessel 3, as illustrated in FIGS. 5B and 5C. However, the vertical frame members in any one of the first supporting frame 30 and the second supporting frame 20 can be also placed such that the first supporting frame 30 and the second supporting frame 20 are faced to each other with the vacuum vessel 3 sandwiched therebetween. It is possible to determine, as required, the shapes and the numbers of the frame members constituting the first and second supporting frames 20 and 30, and the method for coupling them to each other. However, it is preferable that the materials of them are metals, in view of the strength.

### Second Embodiment

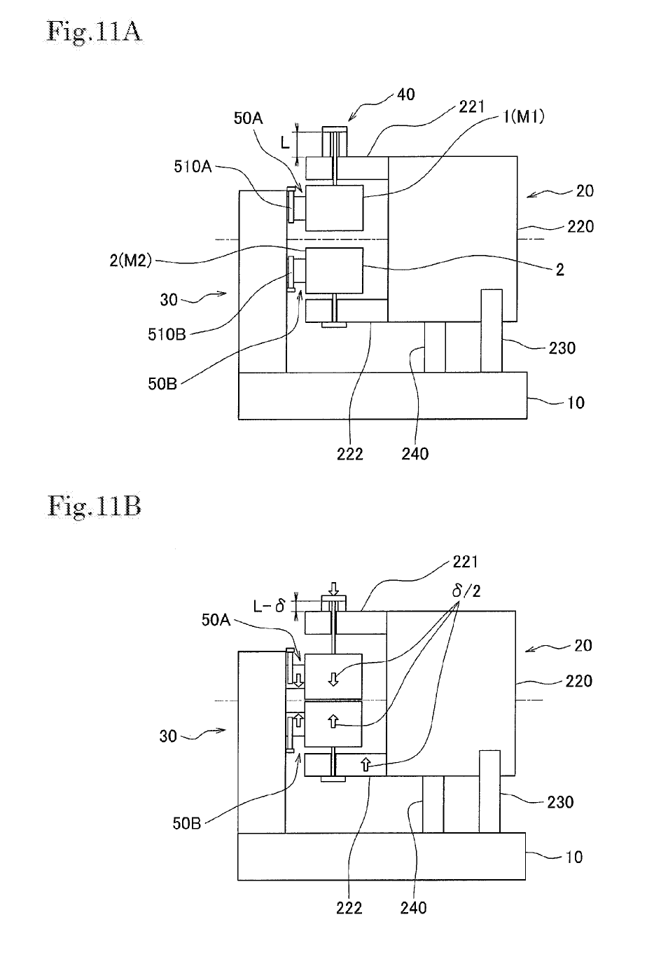

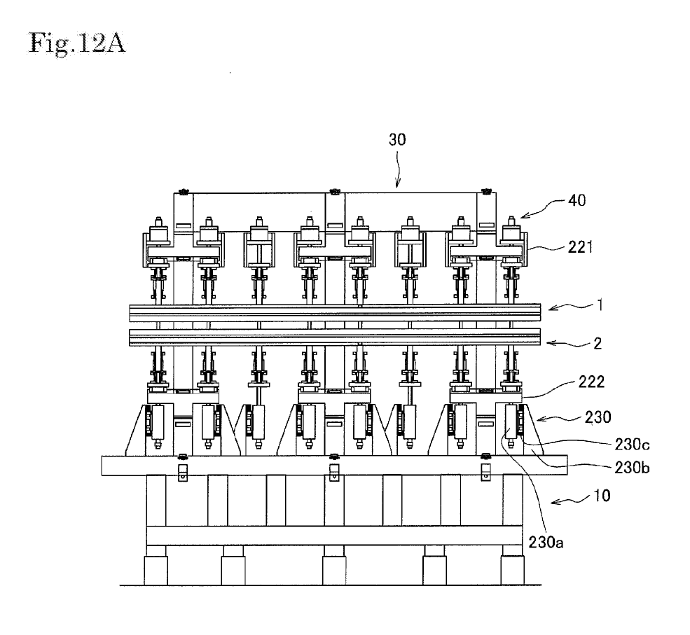

Next, an insertion device according to a second embodiment will be described. In the embodiment having been described above, the compensation spring mechanisms 40 are provided for both the first magnet supporting member 1 and the second magnet supporting member 2. However, in the second embodiment, compensation spring mechanisms 40 are provided for only a first magnet supporting member 1 positioned in an upper side. FIGS. 11A and 11B are schematic views illustrating the structure according to the second embodiment.

As illustrated in FIG. 11A, a first magnet array M1 and a first magnet supporting member 1 can be moved in the vertical direction through a gap driving mechanism 50A in the upper side. A second magnet array M2 and a second magnet supporting member 2 can be moved in the vertical direction through a gap driving mechanism 50B in the lower side. There is provided an upper-side guide mechanism 510A for guiding the first magnet array M1 and the first magnet supporting member 1 in the vertical direction. There is provided a lower-side guide mechanism 510B for guiding the second magnet array M2 and the second magnet supporting member 2 in the vertical direction. The gap driving mechanisms are supported by a first supporting frame 30.

A second supporting frame 20 is constituted by a frame main body 220, a first supporting portion 221, and a second supporting portion 222. The frame main body 220, the first supporting portion 221, and the second supporting portion 222 are integrally coupled to each other. The first magnet supporting member 1 is supported by the first supporting portion 221 with the compensation spring mechanisms 40 interposed therebetween. The second magnet supporting member 2 is secured to the second supporting portion 222.

The frame main body 220 is guided in the vertical direction through linear-motion rails (corresponding to a frame guide mechanism) 230. Supporting springs (corresponding to a supporting elastic member) 240 are interposed between the frame main body 220 and a common base 10, so that the frame main body 220 is supported by the common base 10.

FIG. 11B illustrates operations for reducing the gap interval by δ. For attaining this, the first magnet supporting member 1 is lowered by δ/2 through the gap driving mechanism 50A, and the second magnet supporting member 2 is raised by δ/2 through the gap driving mechanism 50B. At this time, the second supporting frame 20 is also raised by δ/2, since the second magnet supporting member 2 and the entire second supporting frame 20 are integrated. As a result, the springs in the compensation spring mechanisms 40 are shrunk by δ. Arrows illustrate the directions of movements of the respective portions. Accordingly, assuming that the initial length of the springs in the compensation spring mechanisms 40 is L, the length thereof becomes L−δ, after the gap interval is reduced.

The springs can be used in a more stable state, as the springs are compressed by a larger amount. When the compensation spring mechanisms 40 are provided in the upper and lower sides, the springs in the compensation spring mechanisms 40 in the upper and lower sides are each shrunk by δ/2. In the case of the second embodiment, these springs are shrunk by δ and, therefore, the springs can be used in a more stable state. Further, in the case of the second embodiment, it is possible to reduce the number of the compensation spring mechanisms 40 installed therein, which provides an advantage in view of the cost.

The second supporting frame 20 is adapted to be movable in the vertical direction, in entirety. Since the supporting springs 240 are provided, the second supporting frame 20 can be supported by the common base 10 in a stabilized state. In this case, the supporting elastic member is not necessarily required to have a spring force as the compensation spring mechanisms. The supporting elastic member can be other elastic members than springs. As the elastic member, it is also possible to employ a hydraulic mechanism filled with a liquid, for example.

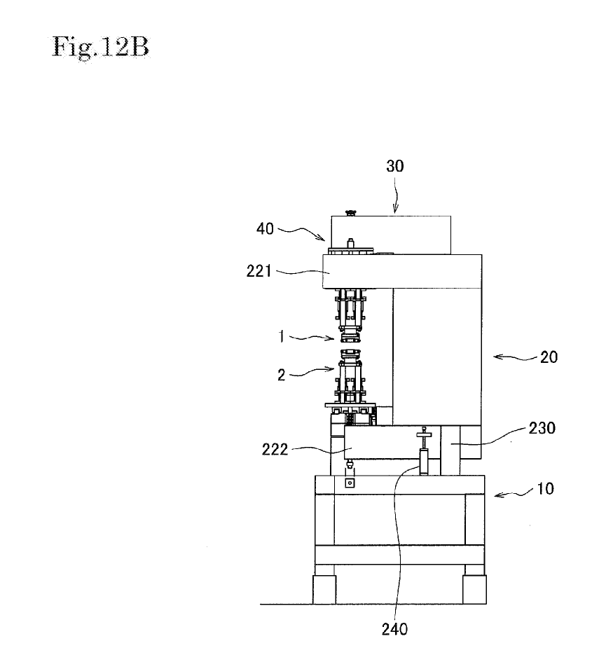

FIG. 12 is a view illustrating, in detail, the structure according to the second embodiment. FIGS. 12A and 12B illustrate a front view and a side view of the same, respectively. The compensation spring mechanisms 40 are provided for only the first magnet supporting member 1 in the upper side, and the number of the compensation spring mechanisms 40 installed therein is 8. In comparison with the cases of providing the compensation spring mechanisms 40 for both the first magnet supporting member 1 and the second magnet supporting member 2, the number of the compensation spring mechanisms 40 installed therein is reduced by half, which is advantageous in view of the cost. Further, the number of the linear-motion rails 230 installed therein and the number of the supporting springs 240 installed therein are also 8. The linear-motion rails 230 are constituted by a first rail supporting member 230a, a second rail supporting member 230b, and a rail member 230c.

### Third Embodiment

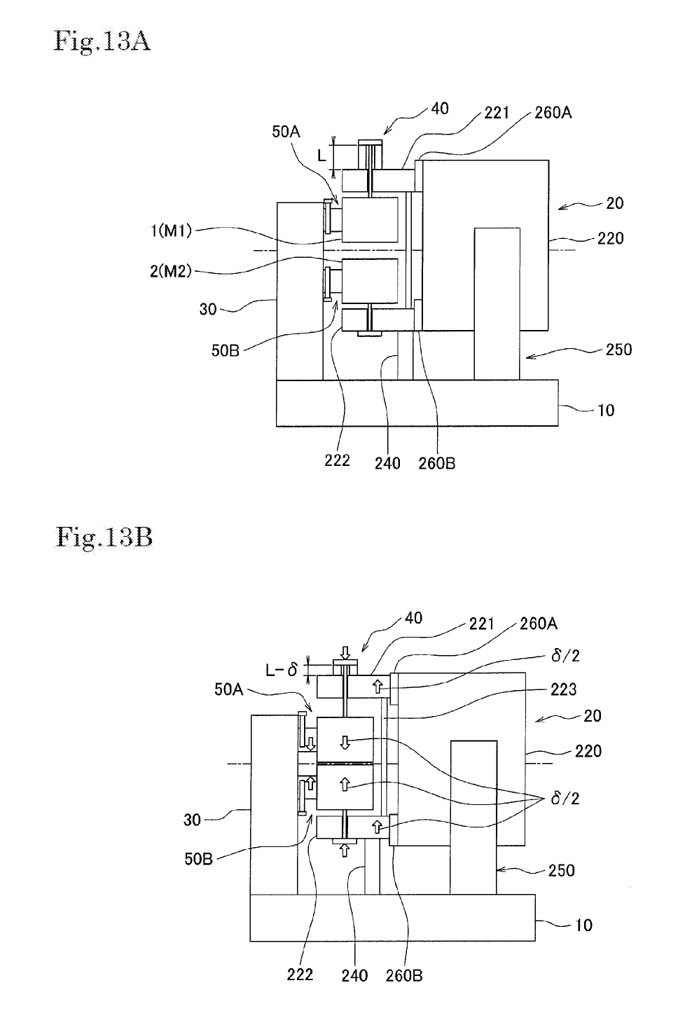

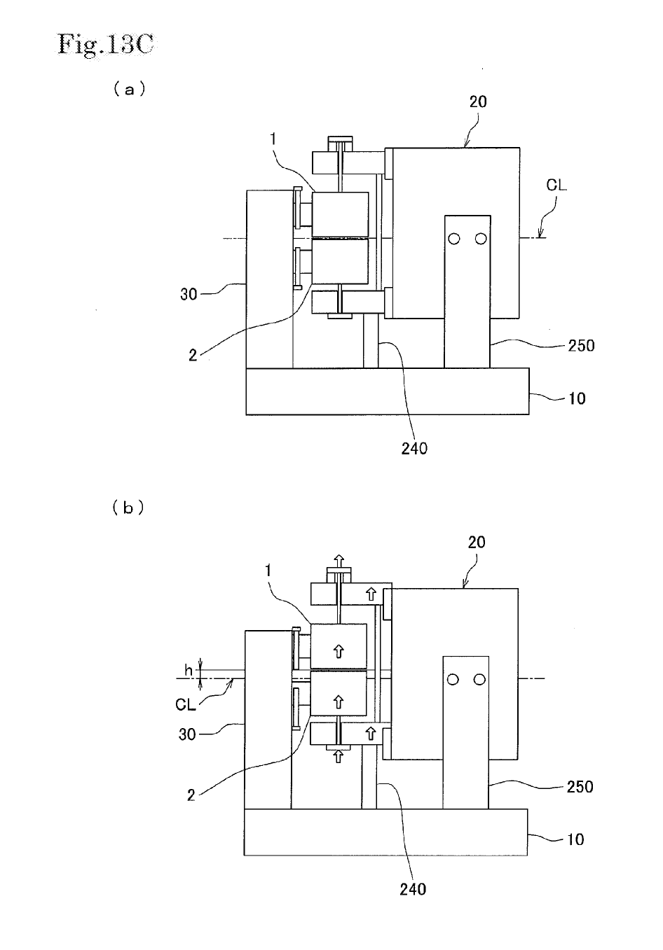

In a third embodiment, similarly to in the second embodiment, compensation spring mechanisms 40 are provided for only a first magnet supporting member 1 positioned in an upper side. FIGS. 13A and 13B are schematic views illustrating the structure according to the third embodiment.

A second supporting frame 20 is constituted by a frame main body 220, a first supporting portion 221, and a second supporting portion 222. However, the first supporting portion 221 is mounted to the frame main body 220 movably in the vertical direction, through linear-motion rails 260A. The second supporting portion 222 is mounted to the frame main body 220 movably in the vertical direction, through linear-motion rails 260B. These linear-motion rails 260A and 260B correspond to a supporting-portion guide mechanism. Further, the first supporting portion 221 and the second supporting portion 222 are integrally coupled to each other through a tension rod 223 (corresponding to a coupling member). Thus, a compression force is exerted on the tension rod 223, and a moment load is exerted on the frame main body. The tension rod 223 is necessary for reducing the gap interval, but the tension rod 223 can be adapted to be removable when the insertion device is not driven. The frame main body 220 is installed on a common base 10 through an installation member 250. The installation member 250 functions as a portion of the frame main body 220. The other structures are the same as those according to the second embodiment. The coupling member is constituted by a non-magnetic material and is required only to have rigidity enough not to bend due to flections of the linear-motion rails 260A and 260B.

FIG. 13B illustrates operations for reducing the gap interval by δ. For attaining this, the first magnet supporting member 1 is lowered by δ/2 through the gap driving mechanism 50A, and the second magnet supporting member 2 is raised by δ/2 through the gap driving mechanism 50B. At this time, the second magnet supporting member 2, the second supporting portion 222, the tension rod 223, and the first supporting portion 221 are integrally raised by δ/2. The frame main body 220 is not moved, since it is secured to the common base 10. As a result thereof, the springs in the compensation spring mechanisms 40 are shrunk by δ. Arrows illustrate the directions of movements of the respective portions. Accordingly, assuming that the initial length of the springs in the compensation spring mechanisms 40 is L, the length thereof becomes L−δ, after the gap interval is reduced.

The second supporting portion 222 is adapted to be movable in the vertical direction, but can be supported by the common base 10 in a stable state due to the provision of the supporting springs 240.

FIG. 13C is a view illustrating a state where a gap center line CL is changed. Changing the gap center line CL is a necessary function for adjusting the position of the electron beam through the variation of the floor surface on which the insertion device is installed.

For example, when the gap center line CL is moved by h upwardly, the first magnet supporting member 1 and the second magnet supporting member 2 are raised together by h. In this case, the first supporting portion 221, the second supporting portion 222 and the tension rod 223 are integrally moved upwardly by h. Accordingly, the compensation spring mechanisms 40 are moved upwardly by the same amount h, the gap center line CL can be changed while the amount of shrinkage of the springs is maintained.

In cases where the compensation spring mechanisms 40 are provided in the upper and lower sides, the springs in the compensation spring mechanisms 40 in the upper side are shrunk by a different amount from that of the springs in the compensation spring mechanisms 40 in the lower side and, therefore, the springs in the upper side exhibit different characteristics from those of the springs in the lower side. In the cases of the second and third embodiments, such inconveniences do not occur.

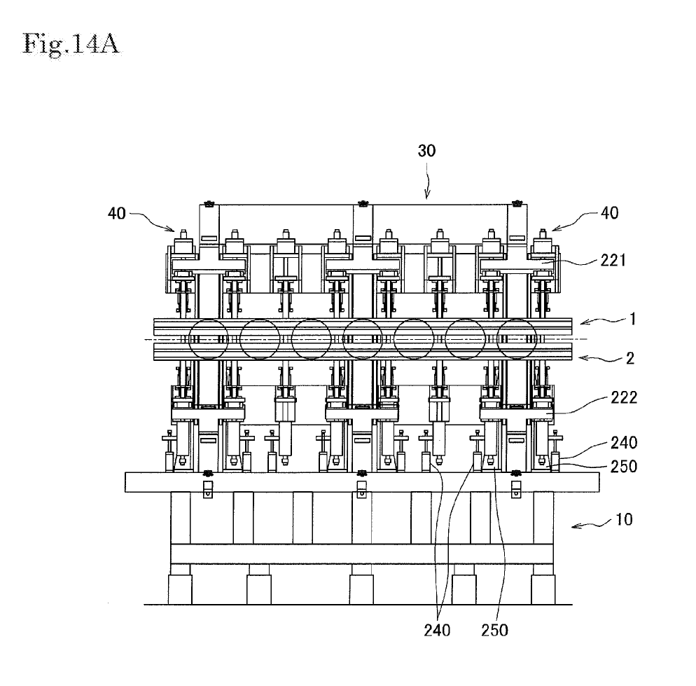

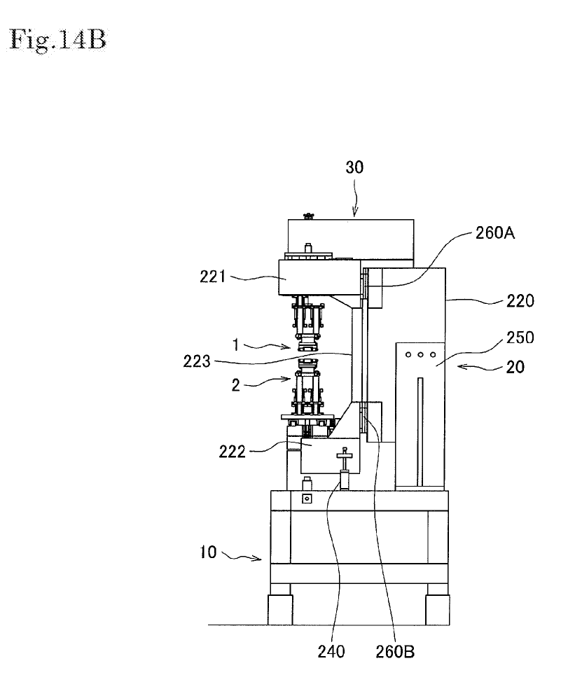

FIG. 14 is a view illustrating, in detail, the structure according to the third embodiment. FIGS. 14A and 14B illustrate a front view and a side view of the same, respectively.

### Other Embodiments

In cases where compensation spring mechanisms 40 are provided for only one of a first magnet supporting member 1 and a second magnet supporting member 2, the compensation spring mechanisms 40 can be provided either for the first magnet supporting member 1 or for the second magnet supporting member 2.

Although the present invention has been described with respect to insertion devices having a first magnet array and a second magnet array which are installed inside a vacuum vessel, the present invention can be also applied to insertion devices having a first magnet array and a second magnet array which are installed in an upper side and a lower side outside a vacuum vessel.

Further, the present invention can be also applied to insertion devices having a first magnet array and a second magnet array which are installed inside a vacuum vessel and being adapted to be used after cooling the first magnet array and the second magnet array, as disclosed in WO2005/72029.

### DESCRIPTION OF REFERENCE SIGNS

S1 Placement space
M1 First magnet array
M2 Second magnet array
δ Gap
1 First magnet supporting member
2 Second magnet supporting member
3 Vacuum vessel
4 Pedestal
5 First coupling shaft
6 Second coupling shaft
7 LM guide supporting member
8 Horizontal LM guide
10 Common base
20 Second supporting frame
200, 201 Second vertical frame member
202 Reinforcement frame
203 Second horizontal frame member
204 C-shaped reinforcement frame
220 Frame main body
221 First supporting portion
222 Second supporting portion
230 Linear-motion rail
240 Supporting spring
250 Installation member
260A, 260B Linear-motion rail
30 First supporting frame
300 First vertical frame member
301 First horizontal frame member
40 Compensation spring mechanism
400 Securing plate
401 Movable plate
402 Coil spring
403 Spring securing seat
404 Pusher
409 Engagement member
409a Engagement surface
420 Coupling rod
421 Engagement member
421a Engagement surface
50, 50A, 50B Gap driving mechanism
506 Supporting member

1. An insertion device comprising:
a first magnet array including a plurality of magnets placed in an array;
a first magnet supporting member adapted to support the first magnet array which is mounted to the first magnet supporting member;
a second magnet array including a plurality of magnets placed in an array and being faced to the first magnet array with a gap interposed between the first magnet array and the second magnet array;
a second magnet supporting member adapted to support the second magnet array which is mounted to the second magnet supporting member;
a gap driving mechanism for driving the first magnet supporting member and/or the second magnet supporting member in a vertical direction for changing a size of the gap;
a driving conjunction mechanism for coupling the gap driving mechanism and the magnet supporting members to each other;
a compensation spring mechanism adapted to act in such a direction as to compensate for an attractive force acting on the first magnet array and the second magnet array;
a spring conjunction mechanism for coupling the compensation spring mechanism and the magnet supporting members to each other;
a first supporting frame for supporting the gap driving mechanism;
a second supporting frame for supporting the compensation spring mechanism; and
a common base placed on a placement surface;
wherein
the first supporting frame and the second supporting frame are individually coupled to the common base.

2. The insertion device according to claim 1, wherein
the first supporting frame includes at least a first vertical frame member and a first horizontal frame member,
the second supporting frame includes at least a second vertical frame member and a second horizontal frame member, and
the first vertical frame member and the second vertical frame member have respective cross-sectional shapes in a horizontal direction which are such shapes that one of the first vertical frame member and the second vertical frame member surrounds the other one.

3. The insertion device according to claim 2, wherein
one of the first horizontal frame member and the second horizontal frame member is placed higher or lower than the other one.

4. The insertion device according to claim 2, wherein
the compensation spring mechanism is mounted on the second horizontal frame member, and
the second horizontal frame member is placed in both right and left sides or in one side with respect to the first vertical frame member.

5. The insertion device according to claim 2, wherein
the compensation spring mechanism includes at least one coil spring, and a spring-force exerting member for exerting the coil spring in such a direction as to compress the coil spring, and
the spring conjunction mechanism has a function of coupling the spring-force exerting member and the magnet supporting members to each other.

6. The insertion device according to claim 2, wherein
the compensation spring mechanism includes a plurality of coil springs, and includes a spring-force adjustment mechanism for adjusting spring forces of the respective coil springs.

7. The insertion device according to claim 1, wherein the driving conjunction mechanism is provided above or below the gap in the vertical direction.

8. The insertion device according to claim 1, wherein
the compensation spring mechanism is provided for only one of the first magnet supporting member and the second magnet supporting member,
the second supporting frame includes a frame main body portion, a first supporting portion, and a second supporting portion,
the compensation spring mechanism is installed on the first supporting portion,
the other one of the first magnet supporting member and the second magnet supporting member, for which the compensation spring mechanism is not provided, is secured to the second supporting portion and, further, includes a frame guide mechanism for guiding movement of the second supporting frame in vertically upward and downward directions, and
the second supporting frame is placed on the common base with the frame guide mechanism interposed between the second supporting frame and the common base.

9. The insertion device according to claim 1, wherein
the compensation spring mechanism is provided for only one of the first magnet supporting member and the second magnet supporting member,
the second supporting frame includes a frame main body portion, a first supporting portion, and a second supporting portion,
the compensation spring mechanism is installed on the first supporting portion, and
the other one of the first magnet supporting member and the second magnet supporting member, for which the compensation spring mechanism is not provided, is secured to the second supporting portion and, further, includes a supporting-portion guide mechanism for guiding movement of the first supporting portion and the second supporting portion in vertically upward and downward directions, with respect to the frame main body portion.

10. The insertion device according to claim 9, wherein there is provided a coupling member for coupling the first supporting portion and the second supporting portion to each other.

11. The insertion device according to claim 8, wherein there is provided a supporting elastic member for supporting the second supporting frame on the common base.

12. The insertion device according to claim 3, wherein
the compensation spring mechanism is mounted on the second horizontal frame member, and
the second horizontal frame member is placed in both right and left sides or in one side with respect to the first vertical frame member.

13. The insertion device according to claim 9, wherein there is provided a supporting elastic member for supporting the second supporting frame on the common base.

14. The insertion device according to claim 10, wherein there is provided a supporting elastic member for supporting the second supporting frame on the common base.
